(19) United States
(12) Patent Application Publication
(10) Pub. No.: US 2018/0018637 A1
(43) Pub. Date: Jan. 18, 2018

(54) METHOD, SYSTEM AND NON-TEMPORARY COMPUTER-READABLE RECORDING MEDIUM FOR SUPPORTING SCHEDULE MANAGEMENT

(71) Applicant: Konolabs, Inc., Seoul (KR)

(72) Inventors: Joon Hee Kim, Seongnam-si (KR); Jung Hee Ryu, Seoul (KR)

(73) Assignee: Konolabs, Inc., Seoul (KR)

(21) Appl. No.: 15/718,774

(22) Filed: Sep. 28, 2017

Related U.S. Application Data
(63) Continuation of application No. PCT/KR2015/009216, filed on Sep. 2, 2015.

(30) Foreign Application Priority Data
Aug. 28, 2015 (KR) 10-2015-0122098

(51) Int. Cl. G06Q 10/10

(52) U.S. Cl. CPC G06Q 10/1095

(57) ABSTRACT

A method for supporting schedule management is provided. The method includes collecting history data with respect to the implementation of the schedule by a user; in reference to the collected history data, estimating a pattern with respect to the implementation of the schedule of the user or another user related to the user; and, in reference to the estimated pattern, setting a policy to be applied to schedule management of the user or the another user.

### CROSS-REFERENCE TO RELATED APPLICATIONS

This application is a continuation application of Patent Cooperation Treaty (PCT) international application Serial No. PCT/KR2015/009216, filed on Sep. 2, 2015, which claims priority to Korean Patent Application Serial No. 10-2015-0122098, filed on Aug. 28, 2015. The entire contents of PCT international application Serial No. PCT/KR2015/009216, and Korean Patent Application Serial No. 10-2015-0122098 are hereby incorporated by reference.

### FIELD OF THE INVENTION

The present invention relates to a method, system, and non-transitory computer-readable recording medium for supporting schedule management.

### BACKGROUND

In order to create a new event in a conventional calendar program (or application), a user should personally find an empty time slot in a time table, and manually enter specific information on the event one by one, such as a to-do item, location, start time, end time, recurrence, and notification time before the event. Therefore, a problem occurs in that the user should take much time and effort to manage schedule. Although a variety of calendar programs are developed recently, those calendar programs simply differ in terms of exterior elements such as designs or titles, and basically have the same problem as above.

Further, a conventional calendar program may only provide schedule management functionality for a single user, and thus, when managing an event in which two or more users are involved, the users cannot avoid the inconvenience of personally contacting each other separately from the calendar program to discuss about the time or location of the event, and entering information on the determined time or location of the event into the calendar program, one by one.

Meanwhile, in order to address the above problem of conventional calendar programs, there have been introduced programs for supporting convenient management of to-do lists. Such a to-do list management program may function to allow a user to conveniently enter and list his/her to-do items and to check the completion of the to-do items, but cannot give consideration to the duration of each to-do item or other events included in the user's schedule. Thus, the program has a limitation in that it is difficult to generally manage the user's schedule using the program.

In this connection, the inventor(s) present a technique for providing improved schedule management to a user on the basis of history data obtained from the user's experience in schedule implementation.

### SUMMARY OF THE INVENTION

One object of the present invention is to solve all the above problems in prior art.

Another object of the invention is to provide improved schedule management to a user using history data obtained from the user's experience in schedule implementation, by collecting history data on schedule implementation of a user; estimating a pattern of schedule implementation of the user or another user related to the user, with reference to the collected history data; and determining a policy to be applied to schedule management of the user or the another user, with reference to the estimated pattern.

The representative configurations of the invention to achieve the above objects are described below.

According to one aspect of the invention, there is provided a method for supporting schedule management, comprising the steps of: collecting history data on schedule implementation of a user; estimating a pattern of schedule implementation of the user or another user related to the user, with reference to the collected history data; and determining a policy to be applied to schedule management of the user or the another user, with reference to the estimated pattern.

According to another aspect of the invention, there is provided a system for supporting schedule management, comprising: a schedule implementation history analysis unit configured to collect history data on schedule implementation of a user, and to estimate a pattern of schedule implementation of the user or another user related to the user, with reference to the collected history data; and a schedule management unit configured to determine a policy to be applied to schedule management of the user or the another user, with reference to the estimated pattern.

In addition, there are further provided other methods and systems to implement the invention, as well as non-transitory computer-readable recording media having stored thereon computer programs for executing the methods.

According to the invention, it is possible to provide improved schedule management to a user using history data obtained from the user's experience in schedule implementation, so that the schedule of the user may be managed to conform to a pattern of schedule implementation of the user even if the user does not manage each of settings regarding numerous events included in the schedule of the user.

### BRIEF DESCRIPTION OF THE DRAWINGS

FIG. 1 schematically shows the configuration of an entire system for supporting schedule management according to one embodiment of the invention.

FIG. 2 illustratively shows the internal configuration of a service provision system according to one embodiment of the invention.

FIG. 3 illustratively shows how a service for supporting schedule management is provided according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of an Entire System

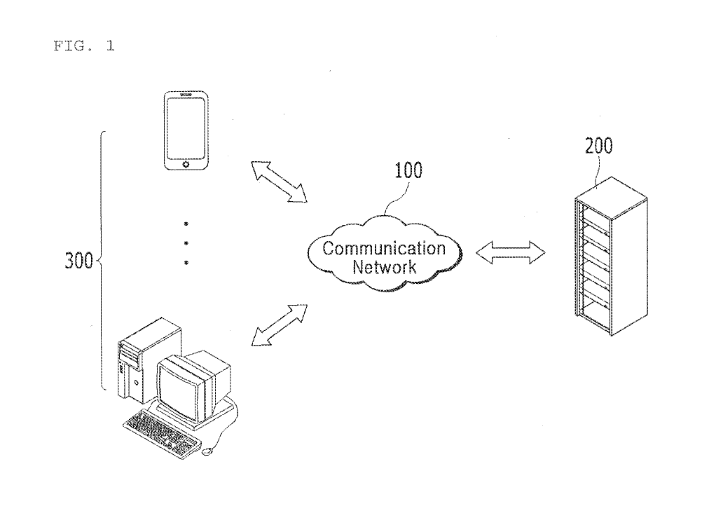

FIG. 1 schematically shows the configuration of an entire system for supporting schedule management according to one embodiment of the invention.

As shown in FIG. 1, the entire system according to one embodiment of the invention may comprise a communication network 100, service provision system 200, and a user terminal device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television networks.

Next, the service provision system 200 according to one embodiment of the invention may function to provide improved schedule management to a user using history data obtained from the user's experience in schedule implementation, by collecting history data on schedule implementation of a user; estimating a pattern of schedule implementation of the user or another user related to the user, with reference to the collected history data; and determining a policy to be applied to schedule management of the user or the another user, with reference to the estimated pattern.

The configuration and function of the service provision system 200 according to the invention will be discussed in detail in the following description.

Next, according to one embodiment of the invention, the user terminal device 300 is digital equipment capable of allowing a user to connect to and then communicate with the service provision system 200, and any type of digital equipment having a microprocessor and a memory means for computing capabilities, such as smart phones, tablets, desktop computers, notebook computers, workstations, personal digital assistants (PDAs), web pads, and mobile phones, may be adopted as the user terminal device 300 according to the invention.

Particularly, the user terminal device 300 may include an application (not shown) to assist a user to receive services from the service provision system 200. The application may be downloaded from the service provision system 200 or a known web server (not shown). It is apparent that the application may be provided by implementing a calendar GUI of a conventional calendar program (e.g., a calendar GUI for schedule management in Microsoft Outlook), as necessary. At least a part of information for constructing the calendar GUI may be received from the service provision system 200.

Configuration of the Service Provision System

Hereinafter, the internal configuration of the service provision system 200 crucial for implementing the invention and the functions of the respective components thereof will be discussed.

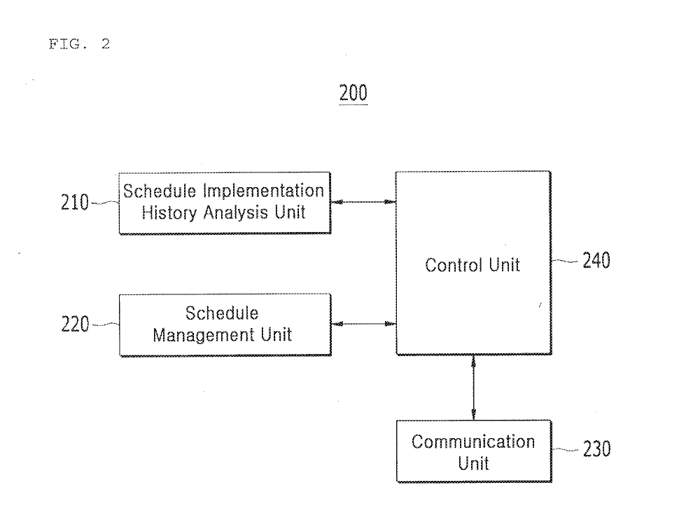

FIG. 2 illustratively shows the internal configuration of the service provision system according to one embodiment of the invention.

Referring to FIG. 2, the service provision system 200 according to one embodiment of the invention may comprise a schedule implementation history analysis unit 210, a schedule management unit 220, a communication unit 230, and a control unit 240. According to one embodiment of the invention, at least some of the schedule implementation history analysis unit 210, the schedule management unit 220, the communication unit 230, and the control unit 240 may be program modules to communicate with an external system (not shown). The program modules may be included in the service provision system 200 in the form of operating systems, application program modules, and other program modules, while they may be physically stored in a variety of commonly known storage devices. Further, the program modules may also be stored in a remote storage device that may communicate with the service provision system 200. Meanwhile, such program modules may include, but not limited to, routines, subroutines, programs, objects, components, data structures, and the like for performing specific tasks or executing specific abstract data types as will be described below in accordance with the invention.

First, according to one embodiment of the invention, the schedule implementation history analysis unit 210 may function to collect history data on schedule implementation of a user. According to one embodiment of the invention, the history data on schedule implementation may consist of data on times or locations obtained from the user terminal device 300, and may be a kind of digital footprints.

Specifically, according to one embodiment of the invention, the history data on schedule implementation may include data on a type, location, scheduled start time, scheduled end time, actual start time, or actual end time of an event related to the user; a distance or time for which the user traveled to attend the event; a time at which the user arrived at the location of the event; a means of transportation that the user used to attend the event; and a time or frequency at which the user creates a second event (i.e., a subsequent event) related to a first event after the first event has ended. Here, the event related to the user may mean an event that the user has attended.

However, it is noted that the history data according to the invention are not necessarily limited to the foregoing, and any data that may be helpful in estimating a pattern of schedule implementation of the user may be used as the history data according to the invention, as long as the objects of the invention may be achieved.

Further, according to one embodiment of the invention, the schedule implementation history analysis unit 210 may function to estimate a pattern of schedule implementation of the user, with reference to the collected history data on schedule implementation of the user.

Meanwhile, according to one embodiment of the invention, the schedule implementation history analysis unit 210 may also estimate a pattern of schedule implementation of another user related to the user, as well as a pattern of schedule implementation of the user, with reference to the collected history data on schedule implementation of the user. Here, according to one embodiment of the invention, it may be considered that a first user and a second user are related to each other when at least a part of the history data on schedule implementation of the first user are common to those of the second user. For example, two users may be related to each other when they have attended an event together, or when they have attended two different events held in the same location, respectively.

Specifically, according to one embodiment of the invention, a pattern of schedule implementation that may be estimated on the basis of the history data may include a frequency at which the user or the another user is late for events, a means of transportation that the user or the another user mainly uses to attend events, a social relationship (e.g., a so-called power dynamic relationship) between two or more users including the user or the another user, and a time period in which the user or the another user is expected to hold an event.

However, it is noted that the pattern of schedule implementation according to the invention is not necessarily limited to the foregoing, and may be changed without limitation as long as the objects of the invention may be achieved.

For example, on the basis of history data indicating that a user was late for seven events out of a total of 100 events held in the first half of 2015, and six out of the seven events were cultural performance events, a pattern may be estimated indicating that the user is frequently late for a cultural performance event.

As another example, on the basis of history data indicating that the distance a first user has traveled is greater than that a second user has traveled for all four business meeting events that the first and second users attended together in the first half of 2015, a pattern may be estimated indicating that the social or business position of the second user is higher than that of the first user.

As yet another example, on the basis of history data indicating that a plurality of dinner events held in the Scandinavian peninsula region where the sun sets early in the winter began earlier than in other regions, a pattern may be estimated indicating that a user who intends to hold a dinner event in the Scandinavian peninsula region is likely to determine the start time of the event to be earlier than in other regions.

Next, according to one embodiment of the invention, the schedule management unit 220 may function to determine a policy to be applied to schedule management of a user or another user related to the user, with reference to the pattern of schedule implementation of the user or the another user.

Specifically, according to one embodiment of the invention, the schedule management unit 220 may determine a notification to be provided to a user, determine a time or location of an event related to the user, or determine a priority of an event related to the user, with reference to information on the pattern estimated on the basis of the history data on schedule implementation.

For example, when a pattern is estimated indicating that a user arrives on time for a 1:1 business meeting event held on a weekday afternoon but is frequently late for an internal meeting held on every Monday morning, a notification, “You have been frequently late for the meeting held on every Monday morning, so how about sleeping a little early on Sunday night?” may be provided to the user at a predetermined time on Sunday evening.

As another example, when a pattern is estimated indicating that a user arrives on time for an event to which the user travels by car but is frequently late for an event to which the user travels on foot, a notification, “Walking may take longer than you think.” may be provided to the user at a predetermined time before a start time of an event.

As yet another example, on the basis of history data that for a plurality of meetings that two or more users including a first user and a second user attended, the distance or time the first user has traveled to attend the meetings is greater than that the second user has traveled to attend the meetings by more than a predetermined level, a pattern may be estimated indicating that the social position of the second user is higher than that of the first user. In this case, a time or location of an event that the first and second users attend may be determined to be more favorable to the second user than the first user.

Meanwhile, according to one embodiment of the invention, the schedule implementation history analysis unit 210 may accumulate information on a social relationship between two or more users, which is estimated from the history data on schedule implementation of the users, thereby constructing a kind of social network containing the information on the social relationship between the users. The schedule management unit 220 may determine a policy to be applied to an event that a plurality of users who have never met or had a direct relationship with each other attend together, with reference to the social network constructed as above.

For example, it may be assumed that on the basis of history data on schedule implementation of a first, second and third users, a social network is constructed indicating that the social position of the second user is higher than that of the first user and the social position of the first user is higher than that of the third user. In this case, for an event that the second and third users who have never met each other attend together, a time or location of the event may be determined to be more favorable to the second user whose social position is estimated to be higher than that of the third user.

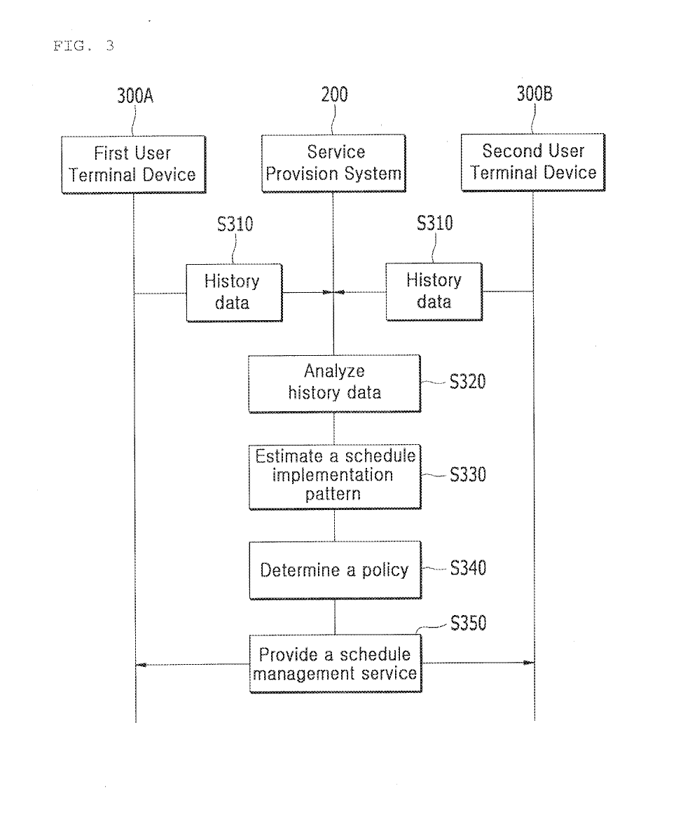

FIG. 3 illustratively shows how a service for supporting schedule management is provided according to one embodiment of the invention.

Referring to FIG. 3, the service provision system 200 according to one embodiment of the invention may obtain history data on schedule implementation from a terminal device 300A of a first user and a terminal device 300B of a second user (or from another user terminal device (not shown) or an external server (not shown)) (S310). Referring further to FIG. 3, the service provision system 200 according to one embodiment of the invention may analyze the collected history data to estimate a pattern of schedule implementation of the first user, second user, or another user (S320, S330). Referring further to FIG. 3, the service provision system 200 according to one embodiment of the invention may determine a policy to be applied to schedule management of the first user, the second user, or another user, with reference to the estimated pattern (S340), and may provide a service for managing schedule of the first user, the second user, or another user according to the determined policy (S350).

However, it is noted that the process of providing recommendation for an event according to the invention is not necessarily limited to the embodiment of FIG. 3, and may be changed without limitation as long as the objects of the invention may be achieved. For example, the history data on schedule implementation of the first or second user may be obtained not only from the terminal devices 300A, 300B of the users, but also from a terminal device of another user (not shown) or an external server (not shown).

Meanwhile, the communication unit 230 according to one embodiment of the invention may function to enable the service provision system 200 to communicate with an external device such as the user terminal device 300.

Lastly, the control unit 240 according to one embodiment of the invention may function to control data flow among the schedule implementation history analysis unit 210, the schedule management unit 220, and the communication unit 230. That is, the control unit 240 may control inbound data flow or data flow among the respective components of the service provision system 200, such that the schedule implementation history analysis unit 210, the schedule management unit 220, and the communication unit 230 may carry out their particular functions, respectively.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for supporting schedule management, comprising the steps of:
collecting history data on schedule implementation of a user;
estimating a pattern of schedule implementation of the user or another user related to the user, with reference to the collected history data; and
determining a policy to be applied to schedule management of the user or the another user, with reference to the estimated pattern.

2. The method of claim 1, wherein the history data on schedule implementation include data on at least one of a type, location, scheduled start time, scheduled end time, actual start time, or actual end time of an event related to the user; a distance or time for which the user traveled to attend an event related to the user; a time at which the user arrived at a location of an event related to the user; a means of transportation that the user used to attend an event related to the user; and a time or frequency at which the user creates, after a first event related to the user has ended, a second event related to the first event.

3. The method of claim 1, wherein at least a part of the history data on schedule implementation of the user are common to the history data on schedule implementation of the another user.

4. The method of claim 1, wherein the pattern of schedule implementation includes at least one of a frequency at which the user or the another user is late, a means of transportation that the user or the another user uses, and a social relationship between two or more users including the user or the another user.

5. The method of claim 1, wherein in the step of determining a policy, a notification to be provided to the user or the another user is determined with reference to the estimated pattern.

6. The method of claim 1, wherein in the step of determining a policy, at least one of a time and a location of an event related to the user or the another user is determined with reference to the estimated pattern.

7. The method of claim 1, wherein in the step of determining a policy, a priority of an event related to the user or the another user is determined with reference to the estimated pattern.

8. A non-transitory computer-readable recording medium having stored thereon a computer program for executing the method of claim 1.

9. A system for supporting schedule management, comprising:
a schedule implementation history analysis unit configured to collect history data on schedule implementation of user, and to estimate a pattern of schedule implementation of the user or another user related to the user, with reference to the collected history data; and
a schedule management unit configured to determine a policy to be applied to schedule management of the user or the another user, with reference to the estimated pattern.

10. The system of claim 9, wherein the history data on schedule implementation include data on at least one of a type, location, scheduled start time, scheduled end time, actual start time, or actual end time of an event related to the user; a distance or time for which the user traveled to attend an event related to the user; a time at which the user arrived at a location of an event related to the user; a means of transportation that the user used to attend an event related to the user; and a time or frequency at which the user creates, after a first event related to the user has ended, a second event related to the first event.

11. The system of claim 9, wherein at least a part of the history data on schedule implementation of the user are common to the history data on schedule implementation of the another user.

12. The system of claim 9, wherein the pattern of schedule implementation includes at least one of a frequency at which the user or the another user is late, a means of transportation that the user or the another user uses, and a social relationship between two or more users including the user or the another user.

13. The system of claim 9, wherein the schedule management unit determines a notification to be provided to the user or the another user, with reference to the estimated pattern.

14. The system of claim 9, wherein the schedule management unit determines at least one of a time and a location of an event related to the user or the another user, with reference to the estimated pattern.

15. The system of claim 9, wherein the schedule management unit determines a priority of an event related to the user or the another user, with reference to the estimated pattern.
